(19) United States
(12) Patent Application Publication
(10) Pub. No.: US 2007/0090139 A1
(43) Pub. Date: Apr. 26, 2007

(54) Slidable pivoting roof rack

(76) Inventor: Robert McKenzie, Cushing, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/256,461

(22) Filed: Oct. 21, 2005

(51) Int. Cl. B60R 9/042; B60P 9/00; B60R 9/00

(52) U.S. Cl. 224/310; 414/462

(57) ABSTRACT

A roof mounted carrying system can be installed on the roof of a vehicle to securely transport a variety of cargo. The carrying system provides features that allow heavy and unwieldy cargo to be conveniently placed or removed from the carrying system without damage to the vehicle or injury to the user. The carrying system includes a base and a tray. The base is attached to the roof of a vehicle. The tray can be slid outwards from the base and rotated in downward direction so that cargo can be conveniently loaded onto the tray. After cargo is placed on the tray, the tray is then rotated upwards and slid back into the base, so that the tray is integral with the base.

### BACKGROUND OF THE INVENTION

1. Field of the Invention

The present invention relates to vehicular carrying systems and, more particularly to roof mounted carrying systems.

2. Description of the Related Art

Many vehicles are equipped by the manufacturer with roof racks. A standard roof rack comprises a pair of spaced parallel rails or load bars, fixedly attached to the roof and aligned parallel to the centerline of the roof or transversely to it. The rails are elevated a slight distance from the roof surface, generally three to five inches. The ends of the rails have end brackets which attach to the roof and hold the rails at the predetermined height. In a common configuration, the brackets for the two transverse rails are adjustably mounted in fixed linear tracks along each side edge of the roof, providing the user with the capability of setting the spacing between the two transverse rails.

These generalized load carriers do not include features for securely holding particular types of equipment. In order to carry a particular type of cargo, a bicycle for example, the user may purchase on the aftermarket a dedicated roof rack that includes features particularized for effectively accommodating that type of cargo. Aftermarket roof racks are available that are installable and removable from the vehicle and may include end brackets that lock into the vehicle's roof gutters or clamp into the top of the side door openings.

User accessibility is a problem with roof racks provided by the manufacturer as well as aftermarket roof racks, particularly the ability of a user to place large ungainly cargo such as a canoe or a bicycle on a roof rack, position the cargo properly on the roof rack, and then fasten that cargo to the roof rack.

Many vehicles, especially those in the sports utility category, have a nominal height range from ground to roof of 65 inches to 80 inches. For example, the Ford Bronco, manufactured by Ford Motor Company of Detroit, Mich., has an advertised nominal roof height of 79.1 inches, and the Chevrolet Suburban, manufactured by Chevrolet Motor Company of Detroit, Mich., has an advertised nominal roof height of 76.4 inches. It is clear that the height of these vehicles is greater than the height of most users so that most users must reach above their heads to place cargo on the roof rack. Furthermore, the roof width for larger vehicles generally falls within the range of 60 inches to 70 inches, making the roof area near the middle of the roof beyond the reach of an average user. Similar problems exist with vans and pickup trucks having caps or removable hardtops installed over their cargo decks. Roof racks for automobiles have the same inherent problems, though lessened because automobiles generally have a lower ground to roof height and a smaller roof width.

Other problems are also inherent in currently available roof racks. In order to load a roof rack, most users must stretch and lean against the vehicle which can result in soiled clothing plus scratches and other damage to the vehicle from buttons and zippers on clothing. Furthermore, the equipment items placed in the roof rack may likewise include metal or abrasive surfaces that may scratch or mar the paint and otherwise cause damage to the vehicle if not handled with appropriate control while being placed in the roof rack and secured. These problems may be further aggravated by loading and unloading the roof rack a number of times.

Loading heavy or unwieldy cargo into existing roof racks also places the user at some risk of injury. A user may resort to balancing on bumpers, hoods, trunks, and in vehicle doorways while loading or unloading cargo, with the obvious potential for injury. The act of lifting heavy or unwieldy objects onto a vehicle roof also has the potential to cause various injuries.

From the forgoing discussion it is clear that a need exists for a roof rack that may be installed on the roof of a vehicle to securely transport a variety of cargo while providing features that allow cargo to be conveniently placed onto the roof rack or removed from the roof rack without damaging the vehicle or causing injury to the user.

### SUMMARY OF INVENTION

The present invention is directed to an apparatus that meets the above-mentioned needs and may provide additional advantages and improvements that will be recognized by those skilled in the art upon review of the present disclosure. The apparatus according to the present invention encompasses a roof rack that may be installed on the roof of a vehicle to securely transport a variety of cargo and that provides features that allow heavy or unwieldy cargo to be conveniently placed onto the roof rack or removed from the roof rack without damage to the vehicle or injury to the user.

A roof rack according to the present invention has two components, a base and a tray. The base is attached to the roof of a vehicle. The tray is attached by pivots to moveable sliders receivably contained in channel components of the base, so that the position of the tray relative to the base changes as the position of the sliders within the channels is changed and the tray may rotate relative to the base about the pivots on the moveable sliders.

The tray has at least two operational positions with respect to the base. These two operational positions are the transport position and the loading position.

When the tray is in the transport position, the tray is locked relative to the base and the tray is positioned integral with the base on the roof of the vehicle. Cargo attached to the tray may be transported by the vehicle when the tray is in the transport position.

When the tray is in the loading position, the tray is extended from the base and rotated so as to make an oblique angle with the base such that the tray extends below the plane defined by the roof of the vehicle. Cargo may be placed on the tray or removed from the tray when the tray is in the loading position. When the tray is in the loading position, user access to the tray is improved which facilitates the placement of cargo on the tray and the removal of cargo from the tray.

The roof rack according to the present invention may be loaded or unloaded by first extending the tray from the base and then rotating the tray so that the tray extends at a downward oblique angle from a plane substantially defined by the base. This action changes the position of the tray from the transport position to the loading position. With the tray in the loading position, cargo may then be placed in the tray or removed from the tray by the user. After cargo is placed in the tray or removed from the tray, the tray may then be placed in the transport position by sliding the tray into the base and rotating the tray upward so that the tray is parallel to the plane substantially defined by the base as the tray is slid back into the base. The tray rotates about pivots on the sliders as so as to be parallel to the plane substantially defined by the roof of the vehicle as the tray is slid into the base.

The base attaches to the roof of the vehicle. In some embodiments, the base may have a number of legs to support the base at a fixed location above the surface of the vehicle roof. The legs may have rubber protectors on the ends that serve to prevent damage to the vehicle. In other embodiments, the base may be designed to be permanently attached to the roof of a vehicle in a number of ways such as by welding the base to the vehicle or bolting the base to the vehicle.

The base may be designed to be removably attached to the roof of a vehicle in other embodiments. Again, a number of fastening techniques may be used for removable attachment of the base such as clamps attached to the base that clamp on the gutters, straps that connect the base to clamps that attach to the gutters, or straps that connect the base to clamps that attach to the doorframe. The base may be designed for removable attachment to factory installed roof racks by clamps. The base may also be designed to be permanently attached to factory installed roof racks by welds or bolts. Such other techniques for either permanently attaching the roof rack to a vehicle or removably attaching the roof rack to a vehicle may be employed as would be recognized by those skilled in the art.

The base in some embodiments may be designed to attach to a particular type of vehicle, a Chevy Suburban for example, or, alternatively, the base may be designed to adjust so as to be installable on a variety of different vehicles.

The tray may be configured so that it may be locked to the base in the transport position and then unlocked from the base so that the tray can be moved into the loading position with a locking mechanism. When the tray is unlocked from the base, the tray is moveable with respect to the base. When the tray is locked to the base, the tray is fixed with respect to the base. The locking mechanisms may be located at an end of the tray. Various suitable locking mechanisms will be recognized by those skilled in the art upon review of the present disclosure and accompanying figures.

A roof rack according to the present invention may be fabricated from metals such as aluminum or steel or from plastics or from combinations of metal and plastic or other materials as would be recognized by one skilled in the art.

### BRIEF DESCRIPTION OF THE DRAWINGS

The features, aspects, and advantages of the present invention will become better understood with respect to the description, claims, and accompanying drawings where:

FIG. 1 is a perspective view of an apparatus in accordance with the present invention;

FIG. 2 is a perspective view of an embodiment of the current apparatus which shows the tray partially withdrawn from the base;

FIG. 3 is a side elevation view partially in phantom of an embodiment of the current apparatus with the tray placed in the transport position and, in phantom, with the tray placed in the loading position;

FIG. 4 is a rear elevation view of an embodiment of the current apparatus placed on the roof of a vehicle;

FIG. 4A is an enlarged rear elevation view of the portion of the current apparatus within the broken circle in FIG. 4;

FIG. 4B is a side elevation view of a portion of the current apparatus;

FIG. 5A shows a side view of the of the current apparatus showing the tray partially extended from the base so that the first slider is between the first and second positions;

FIG. 5B is a side elevation view of the current apparatus showing the slider placed in the second position so that the tray is fully extended from the base but the tray is not rotated about the pivots into the loading position.

FIG. 5C is a side elevation view of the current apparatus showing the first slider placed in the second position so that the tray is fully extended from the base and the tray is rotated about the pivots into the loading position.

### DETAILED DESCRIPTION OF THE INVENTION

The present invention relates to a roof rack that may be installed upon the roof of a vehicle to facilitate placement of cargo thereon. Various embodiments of apparatus and methods in accordance with the present invention are illustrated throughout the figures for exemplary purposes and ease of description.

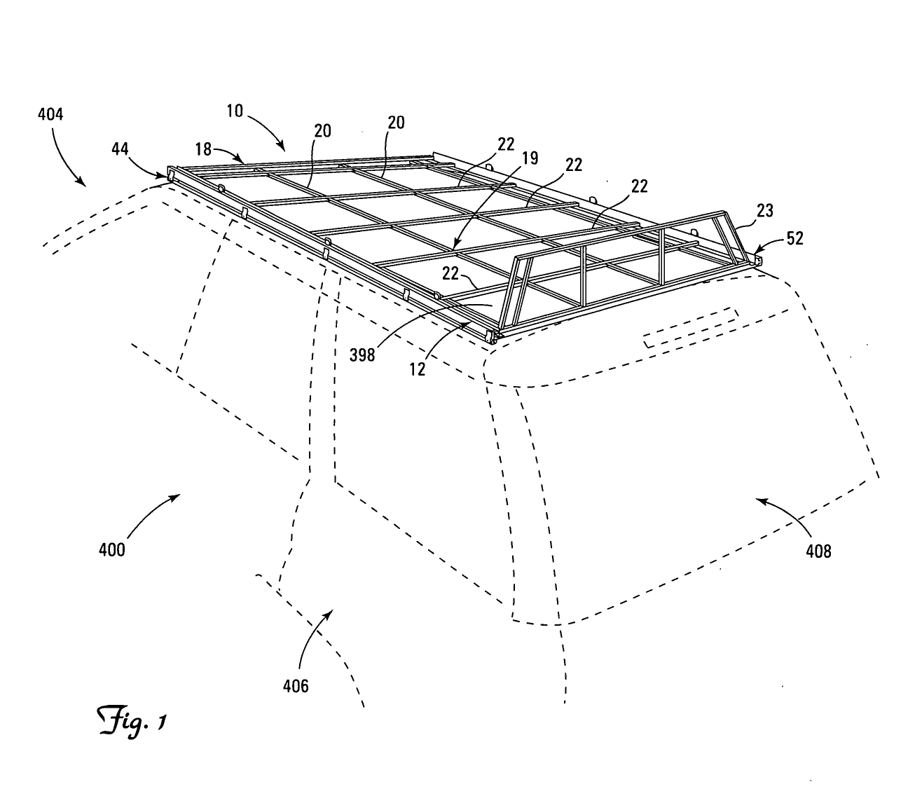

FIG. 1 shows a perspective view of an embodiment of the present invention 10 placed upon the roof 398 of a vehicle 400. The perspective view shows both the vehicle side 406 and the vehicle rear 408 in phantom. The vehicle front 404 is also indicated in this figure. The roof rack of the present invention 10 consists of two main components, a base 44 that engages the roof 398 of the vehicle 400 and a tray 18.

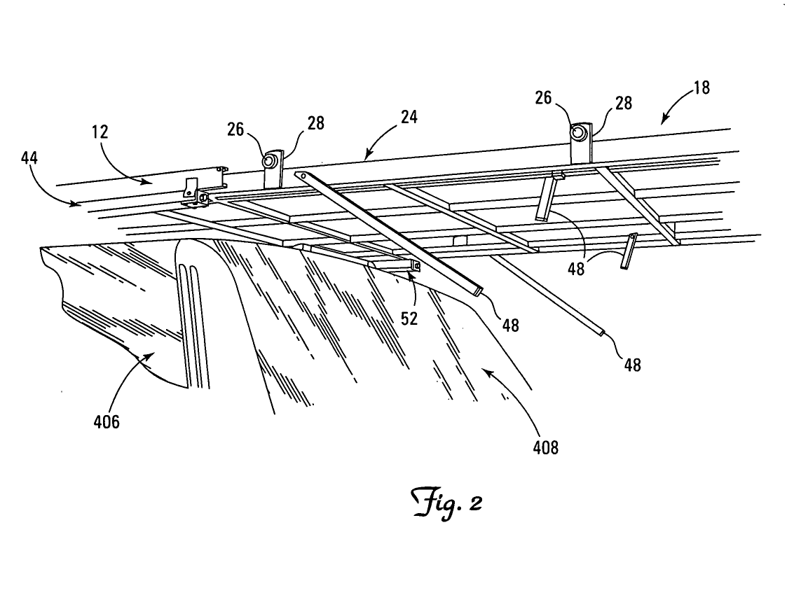

The tray 18 is slidably and pivotably mounted to the base, so that the tray 18 may be placed in a plurality of positions with respect to the base 44 and rotated with respect to the base 44. The tray 18 has two operational positions with respect to the base 44, a transport position and a loading position. The tray 18 is placed into the two operational positions by positioning the tray 18 with respect to the base 44. FIG. 1 shows the tray 18 placed in the transport position. In the transport position, the tray 18 is positioned integral with the base 44 and may be locked to the base 44. The tray 18 in the transport position may be unlocked from the base 44 and placed in the loading position by sliding the tray with respect to the base and then rotating the tray downward with respect to the base, as shown in FIGS. 2, 3, 5A, 5B, and 5C. Various locking mechanisms may be used to lock or unlock the tray 18 to the base 44 when the tray is in the transport position. These locking mechanisms will be recognized by those skilled in the art upon review of the present disclosure and accompanying figures.

The tray 18 provides a framework 19 for the placement of cargo. In the embodiment of FIG. 1, the framework 19 is defined by interlaced longitudinal members 20 and transverse members 22 and also includes a rear support 23. General cargo may be attached to the surface 19 by rubber straps, ropes, or other readily recognized techniques. Other embodiments may include a tray formed from a solid sheet of material or a tray specially configured to receive and transport a specific type of cargo such as, for example, a bicycle, a canoe, a small boat, or skiing equipment.

The tray 18, as shown in the embodiment of FIG. 1, extends over a large portion of the roof 398 of the vehicle 400. In other embodiments, the tray 18 may extend only over a small portion of the roof 398 of the vehicle 400 or, alternatively, the tray may extend beyond the roof 398 of the vehicle 400.

The roof rack of the present invention may be made from steel, aluminum, plastic, wood, combinations thereof, or other materials as would be recognized by those skilled in the art. Various decorative elements could also be incorporated into the various embodiments as well as additional functional features such as reflective surfaces, lights, netting, tarps, cargo covers, attachments for specialized cargo, and attachments that reduce aerodynamic drag when the vehicle is in motion without departing from the scope of the present invention as set forth in the claims.

FIG. 2 shows the tray 18 at a position intermediate between the transport position and the loading position. In the FIG. 2 embodiment, the tray 18 may be extended from the base 44 outward from the rear of the vehicle 408. In other embodiments, the tray 18 may be extended from the base 44 outward from the side of the vehicle 406.

Collapsible support legs 48 may be integral with the tray 18 and receivable within a first channel 12 and a second channel 52, as shown in the embodiment of FIG. 2.

These collapsible support legs 48 may be extended so as to support the tray when the tray is placed in the loading position by engaging with various surfaces including surfaces of the vehicle and surfaces external to the vehicle such as a loading dock or the ground. The tray 18 may also extend to a loading dock or to the ground when placed in the loading position.

In the embodiment shown in FIG. 2, wheel mounting brackets 28 with attached wheels 26 are mounted to the tray 18 in order to facilitate sliding the tray 18 with respect to the base 44. Other embodiments may use various techniques for facilitating the slidability of the tray with respect to the base such as lubricants or wheels, rollers, or bearings mounted either to the tray 18 or to the base 44.

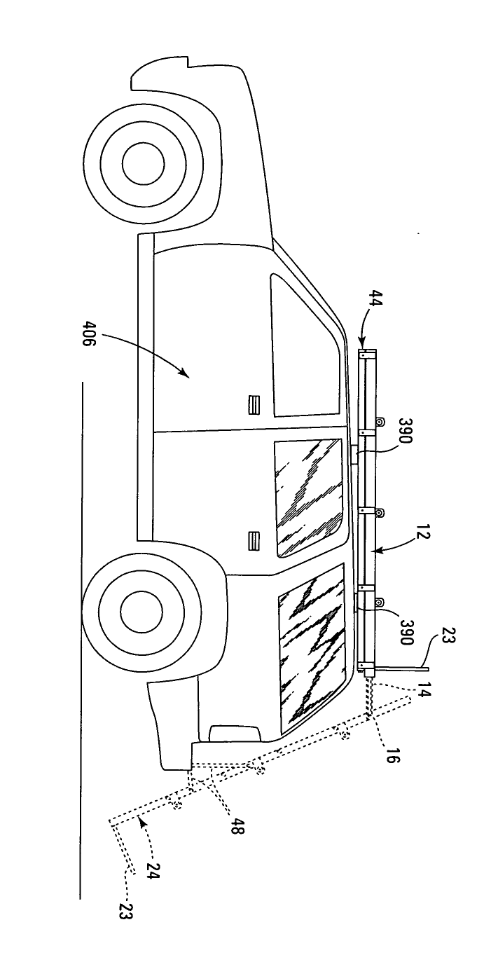

FIG. 3 illustrates both the transport position and the loading position, in phantom, of the tray 18 of an embodiment of the present apparatus which is attached to a factory installed roof rack 390. In the solid view, the tray 18 is shown in the transport position integral with the base 44. In the phantom view, the tray 18 is shown withdrawn from the base 44 to a limiting position and rotated downward with respect to the base into the loading position. The collapsible support legs 48 are extended to support the tray 18 in the loading position.

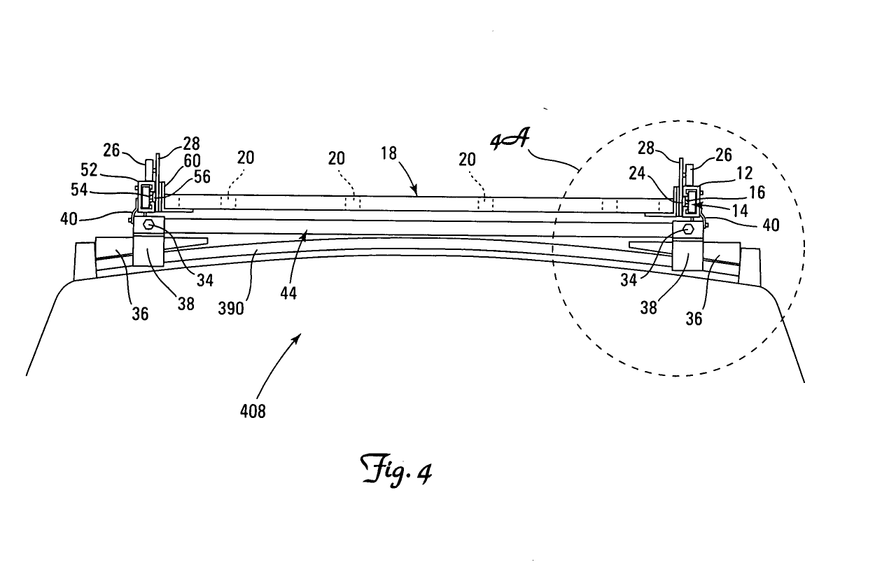

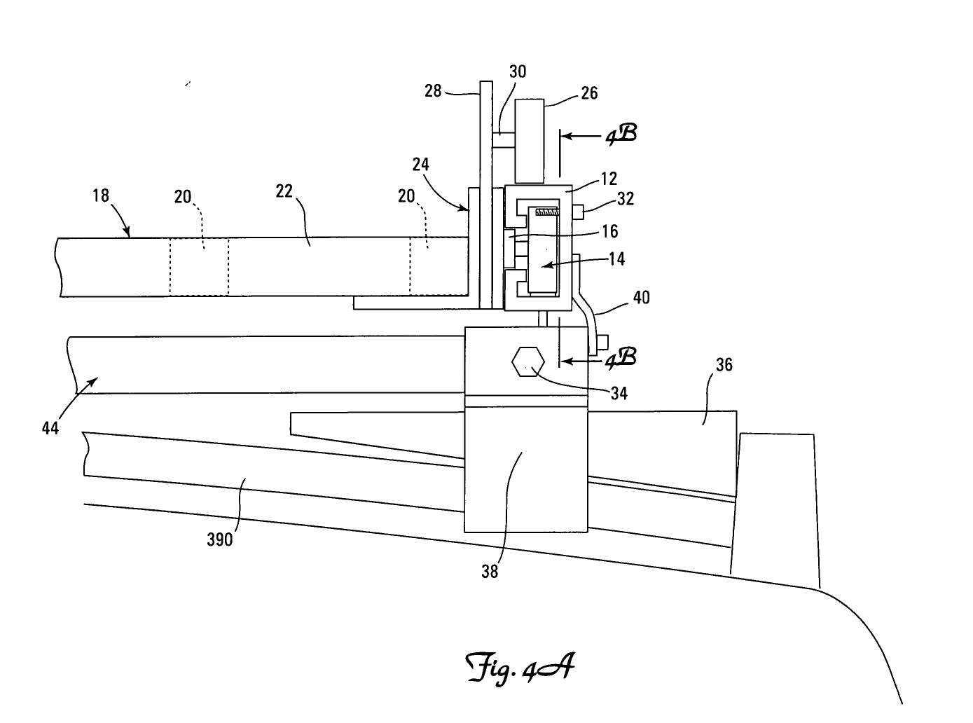

A more detailed rear view of an embodiment of the present apparatus attached to a factory installed roof rack 390 as seen from the vehicle rear 408 is shown in FIG. 4. In this view, the tray 18 is placed in the transport position so as to be integral with the base 44. In the particular embodiment shown in FIG. 4, the base 44 has a first channel 12 and a second channel 52. A first slider 14 is received within the first channel 12 and a second slider 54 is received within the second channel 52. The first slider 14 is positionable at a plurality of locations within the first channel 12 between a first position and a second position. The second slider 54 is positionable at a plurality of locations within the second channel 52 between a first position and a second position. The tray has a first tray side 24 and a second tray side 60. The first tray side 24 is pivotably connected to the first slider 14 by a first pivot 16 and the second tray side 60 is pivotably connected to the second slider 54 by a second pivot 56. The tray 18 is placed in the transport position so as to be integral with the base 44 and the tray may be locked to the base when the first slider 14 and the second slider 54 are both placed in the first position. The tray 18 may then be pivoted downward relative to the base 44 so as to be placed in the loading position when the first slider 14 and the second slider 54 are both placed in the second position.

The embodiment of the roof rack shown in FIG. 4 is detachably mounted to a factory installed roof rack 390 by clamping attachment brackets 38 to the factory installed roof rack 390. In other embodiments of the present apparatus, the roof rack may be detachably mounted to a factory installed roof rack 390 by other mechanisms readily recognizable to one skilled in the art. Additional embodiments of the present apparatus may be designed for vehicles not equipped with a factory installed roof rack 390. Embodiments of the present apparatus for vehicles not equipped with a factory installed roof rack 390 may engage the roof surface by legs, blocks, padding, or combinations thereof or by other techniques recognizable to those skilled in the art, and may attach to the vehicle by clamping the roof rack 10 to the roof gutters, attach to the door frame by straps and hooks, or attach by other mechanisms readily recognizable to those skilled in the art. Other embodiments of the roof rack 10 according to the present invention may be permanently attached to the roof of a vehicle by welds, bolts, or other mechanisms recognizable to those skilled in the art.

FIG. 4A illustrates a more detailed view of the embodiment of the first channel 12 and the first tray side 24 shown in FIG. 4. The embodiment of the second channel 52 and the second tray side 60 is reversed in orientation about the vertical axis but is otherwise substantially similar to the embodiment of the first channel 12 and the first tray side 24 shown in FIG. 4A. In the embodiment of FIG. 4A, the first slider 14 is shown received within the first channel 12 forward of a screw 32, which serves as a stop. A first pivot 16 connects the first slider 14 to the first tray side 24.

In the embodiment shown in FIG. 4A, the tray is formed by interweaving a plurality of transverse members 22 and longitudinal members 20. Wheels 26 on axles 30 are attached to wheel mounting brackets 28. The wheel mounting brackets 28 are, in turn, attached to the first tray side 24 at intervals in order to facilitate movement of the tray between the transport and loading positions. Various lubricants and arrangements of wheels, rollers, and bearings could be used in alternative embodiments. In various embodiments, the first and second side of the tray may be slidably received within the first and second channel, respectively, so that both the first slider and the first tray side and second slider and second tray side are contained within the first channel and second channel, respectively.

In the embodiment shown in FIG. 4A, the base 44 is removably attached to a factory installed roof rack 390 by an attachment bracket 38. Spacers 36, typically made from hard plastic, may be used to level the base 44. The base 44 may be attached to a factory installed roof rack 390 in a variety of other ways. If the vehicle 400 is not equipped with a factory installed roof rack 390, the base 44 may be attached to the vehicle 400 by a variety of techniques.

A cut-away side view of a portion of an embodiment of the first channel as seen from the direction of the arrows 4B in FIG. 4A is shown in FIG. 4B. In this embodiment, the first channel 12 is attached to a base lateral member 50 by support elements 40. The first slider 14 is shown received within the first channel 12. The first slider 14 is connected to the first tray side 24 by a first pivot 16. Two wheels 26 are mounted on the first slider 14 to facilitate movement of the first slider 14 between the first and second positions. Wheels 26 mounted at intervals on the first tray side 24 facilitate movement of the tray 18 between the transport and loading positions. Wheels 26 attached to the tray 18 by wheel mounting brackets 28 facilitate movement of the tray 18.

Also shown in the embodiment of FIG. 4B is an attachment bracket 38 for attaching the base 44 to a factory installed roof rack 390. A bolt 34 engages the attachment bracket 38 such that the attachment bracket 38 may be biased against the factory installed roof rack 390 by turning the bolt 34.

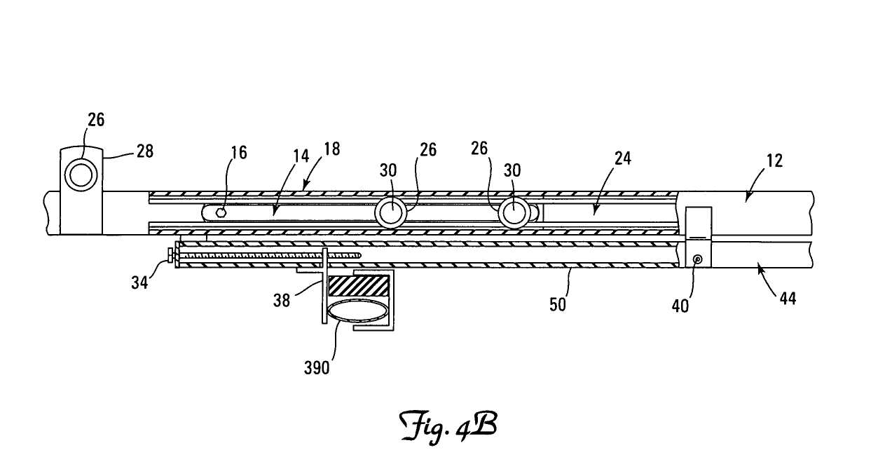

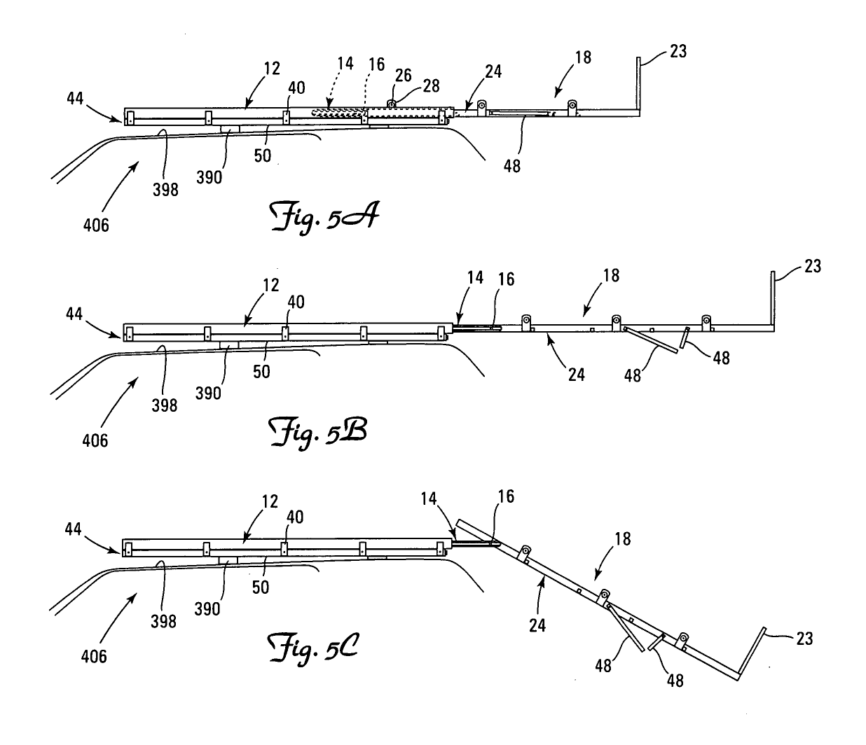

FIGS. 5A-5C illustrate the operation of an embodiment of the roof rack 10 of the present invention through a series of side views that show, respectively, in FIG. 5A, the first slider 14 and tray 18 at a position midway between the first position and the second position, in FIG. 5B, the first slider 14 at the second position, so that the tray 18 is extended to the limit point from the base 44, but prior to rotation of the tray 18 about the first pivot 16 into the loading position, in FIG. 5C, and the first slider 14 in the second position and the tray 18 rotated downward with respect to the base 44 into the loading position. In this specific embodiment, the base 44 is mounted to a factory installed roof rack 390. The first channel 12 is shown attached to a base lateral member by a plurality of support elements 40.

In FIG. 5A, the first slider 14 is shown received within the first channel 12. The first slider 14 is placed at a position intermediate between the first position and the second position. A wheel 26 mounted on a wheel mounting bracket 28 is shown engaged with the first channel 12.

FIG. 5B shows the first slider 14 placed in the second position so that tray 18 is in a limiting position with respect to the base 44. The tray 18 has not been rotated downward with respect to the base 44.

In FIG. 5C, the first slider 14 is placed in the second position and the second slider 54, not shown, is placed in the second position and the tray 18 is rotated about the first pivot 16 on the first slider 14 and the second pivot 56 on the second slider 54, not shown, so as to be placed in the loading position. The collapsible support legs 48 are partly extended in FIGS. 5B and 5C.

Although specific embodiments and methods of use have been illustrated and described herein, it will be appreciated by those of ordinary skill in the art that any arrangement that is calculated to achieve the same purpose may be substituted for the specific embodiments and methods shown. It is to be understood that the above description is intended to be illustrative and not restrictive. Combinations of the above embodiments and other embodiments as well as combinations of the above methods of use and other methods of use will be apparent to those having skill in the art upon review of the present disclosure. The scope of the present invention should be determined with reference to the appended claims, along with the full scope of equivalents to which such claims are entitled.

What is claimed is:

1. A roof rack comprising:
a. A base defining a first channel and a second channel;
b. A first slider moveably received in the first channel positionable at a plurality of locations between a first position and a second position within the first channel;
c. A second slider moveably received in the second channel positionable at a plurality of locations between a first position and a second position within the second channel;
d. A tray pivotably connected to the first slider and the second slider to permit the tray to be pivoted relative to the base when the first slider and the second slider are in a second position.

2. The roof rack of claim 1, wherein the tray is positioned at the rear of the vehicle when the first slider and the second slider are in the second position.

3. The roof rack of claim 1, wherein the tray is positioned at the side of the vehicle when the first slider and the second slider are in the second position.

4. The roof rack of claim 1, further comprising:
a plurality of collapsible support legs attached to the tray the support legs being receivable in the first channel and the second channel.

5. The roof rack of claim 1 further comprising:
a plurality of wheels mounted to a first tray side and to a second tray side, such that the wheels engage the first channel and the second channel.

6. The roof rack of claim 1 further comprising:
a plurality of wheels mounted to the first channel and to the second channel such that the wheels engage a first tray side and a second tray side.

7. The roof rack of claim 1, further comprising two or more wheels are mounted on the first slider and two or more wheels are mounted on the second slider.

8. The roof rack of claim 1, further comprising a support at one end of the said tray.

9. The roof rack of claim 8, wherein said support is substantially perpendicular to said tray.

10. The roof rack of claim 1, further comprising a biasable bracket for attaching said base to a factory installed roof rack.
